(19) United States
(12) Patent Application Publication
(10) Pub. No.: US 2021/0067247 A1
(43) Pub. Date: Mar. 4, 2021

(54) DYNAMIC FREE-SPACE FEMTO-CELLS FOR HIGH SPEED OPTICAL COMMUNICATION

(71) Applicant: E-Lambda LLC, Corvallis, OR (US)

(72) Inventors: Spencer Travis Liverman, Sherwood, OR (US); Jyotindra Raj Shakya, Corvallis, OR (US); Alan Xiaolong Wang, Corvallis, OR (US); Timothy (Thinh) Nguyen, Corvallis, OR (US); Arun S. Natarajan, Corvallis, OR (US)

(21) Appl. No.: 16/424,361

(22) Filed: May 28, 2019

(51) Int. Cl. H04B 10/112

(52) U.S. Cl. CPC H04B 10/112; H04W 84/02

(57) ABSTRACT

A dynamic free-space-optical femto-cell (DFF) communication system is disclosed. The system operates to allow bi-directional communication between transceiver and receivers using free space optics and line of sight alignment and tracking. The system dynamically adjusts beam direction and beam shape in order to maximize power efficiency and maintain line of sight using beam steering and beam forming. The result is greatly reduced power requirement, improved security and dynamic mobility.

### STATEMENT REGARDING FEDERALLY SPONSORED RESEARCH OR DEVELOPMENT

This invention was made with Government support under N6833518C0562 awarded by Naval Air Warfare Center Aircraft Division. The Government has certain rights in this invention.

### BACKGROUND OF THE INVENTION

The present disclosure relates generally to free-space optical communication. More particularly, the present disclosure relates to dynamic free-space femto-cell with adaptive transceiver alignment.

Free-space wireless communication systems such as WiFi are widely used and accepted technologies. However, Radio Frequency (RF) based systems such as Wi-Fi suffer from various limitations such as limited bandwidth, higher power, security and eavesdropping risk and shorter range due to RF signal attenuation in free-space.

Recent advances in free space optical (FSO) technologies promise a new way to provide energy efficient, high speed, and secure wireless communications. Optical communication in contrast to Radio Frequency (RF) communication is based on line-of-sight and hence can be very directional and hence energy efficient and secure. Lasers required for FSO are now available in miniaturized form factor using Vertical Cavity Surface Emitting Laser (VCSEL) technology and due to significant reduction in device capacitance, it can now be modulated at very high frequency. Also, FSO and RF communication devices can operate in the same locations without interference. Importantly, FSO transmissions can be made to directly focus to a particular receiver. Consequently, signal leakage to unwanted receivers such as eavesdropper can be many orders of magnitude smaller and hence not detectable. FSO devices are also resilient to jamming attack since the attacker has to be in close vicinity of the legitimate user and has sufficient power to direct its light to disrupt the receiver's signal. Unlike RF communication where Electromagnetic Pulse (EMP) attack can disrupt RF communication altogether, FSO is inherently immune to such attacks. This invention proposes the first high speed (˜10 s of Gbps), scalable, secure, wireless local area network (WLAN) using an innovative concept called “dynamic” FSO femtocell (DFF) architecture. DFF technology provides the coverage area through a network of collaborative femtocells, which can be dynamically enlarged, reduced, and moved in such a way to optimize throughput, energy, security, and mobility.

### BRIEF SUMMARY OF THE INVENTION

This invention pertains to dynamic free-space optical femto-cell (DFF) communication system and method that provides improved throughput, security and mobility. Exemplary embodiments employ a plurality of DFF that are distributed in space to allow seamless and power optimized transmission of data over free-space to the end-users. The invention further pertains to optimizing each DFF to achieve optimal transmission efficiency, tracking each user, providing communication protocol that includes error correction and encryption and method for ascertaining location of each receiver.

Such FSO links increase link security since optical beams, unlike RF, can be directly focused on specific receivers, limiting information leakage to other receivers that are in close physical proximity. However, achieving FSO links requires holistic end-to-end solutions that address device and system level challenges. In particular, transmitter (TX) and receiver (RX) design must accommodate trade-offs between output power and bandwidth and sensitivity and bandwidth respectively while at the system level, link must be maintained across user mobility while optimizing throughput, energy and security.

The present invention overcomes these challenges using,

(a) Deformable Mirror based beam shaping to dynamically adjust the focus area (femtocell size).

(b) Beam steering that supports different relative positions of TX and RX to provide robust tracking.

(c) Algorithms to perform rapid, real-time beam shaping and beam steering optimized for throughput, mobility, and security.

(d) Energy-efficient integrated Gb/s CMOS optical TX and RX that breaks bandwidth sensitivity trade-offs using a distributed approach.

In addition to high-speed, energy efficiency and cost, FSO reduces increasingly larger burden of cable management with respect to Ethernet connectivity. In terms of communication protocol, which can be seamlessly integrated into FSO technology, solutions range from high-speed networks such as 10 GbE, 40 GbE, 100 GbE, and beyond to more conventional protocols such as the well-known 1 GbE which provides the vast majority of connectivity in today's RF communication systems. There is potential to replace much of the 1 GbE cabling if a secure, wireless system were implemented. Wireless Fidelity (Wi-Fi) is the current method of sending data using RF communication and has become a preferred method of data transmission. At times, Wi-Fi can be very reliable but the Electromagnetic Interference (EMI) it can cause and security vulnerabilities it can create present a problem. Furthermore, Wi-Fi achieves mobility at the cost of omni-directional transmission, which wastes energy and hence is not power efficient. Many new Wi-Fi routers use beam forming to direct RF energy to the users, but the RF beam is still broad, and energy is still wasted.

This invention will overcome most of the challenges and shortcomings of Wi-Fi technology by using line-of-sight optical link that is secure, power efficient and dynamic.

### BRIEF DESCRIPTION OF THE DRAWINGS

FIG. 1 is an illustration of Dynamic Free-Space-Optical Femto-Cell (DFF) communication system

FIG. 2 is an example of Wi-Fi system (Prior Art)

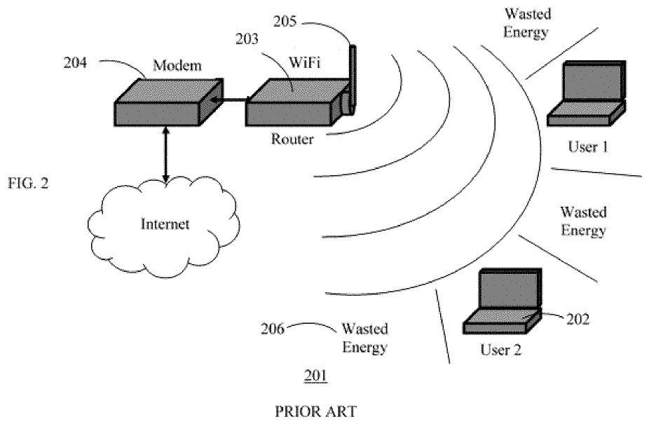

FIG. 3 is a preferred embodiment of DFF communication system

FIG. 4 is a preferred embodiment of user tracking system

FIG. 5 is a preferred embodiment of communication system

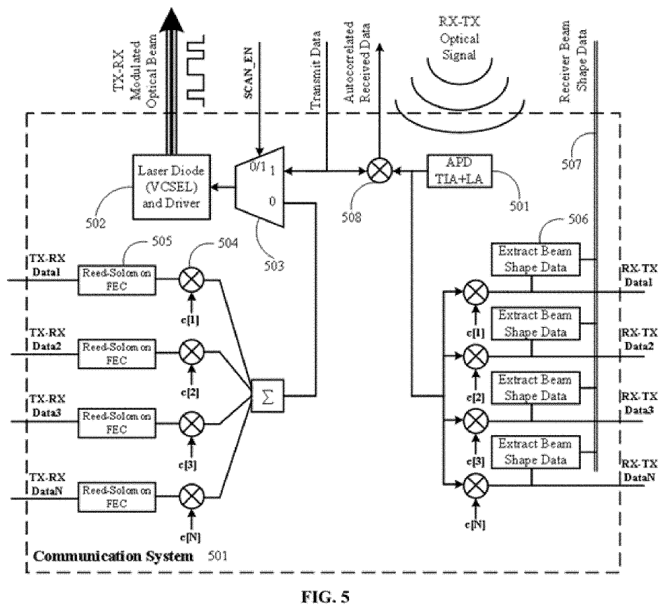

FIG. 6 is a preferred embodiment of receiver system

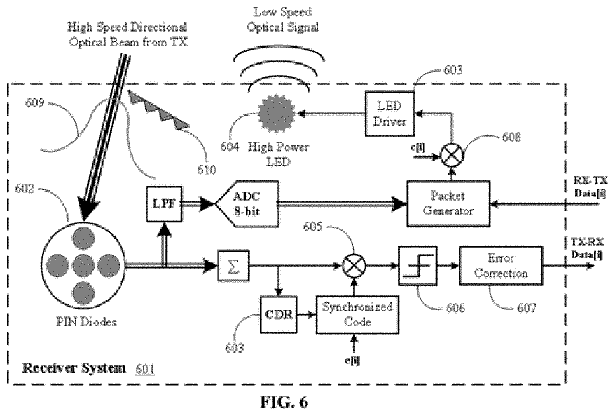

FIG. 7 is illustration of spiral scanning scheme

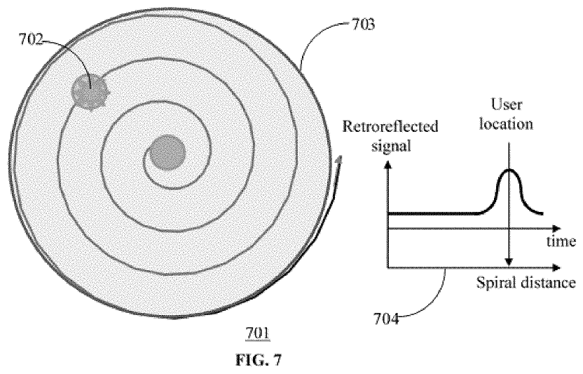

### DETAILED DESCRIPTION OF THE INVENTION

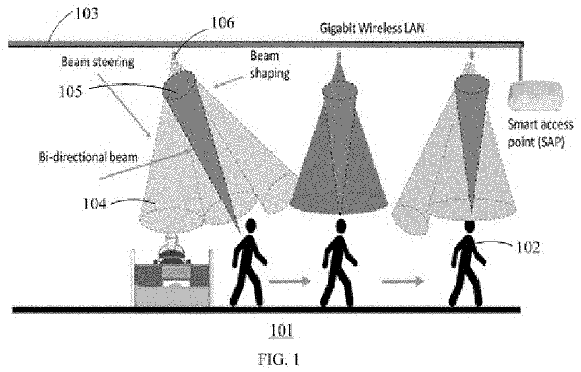

The DFF communication technology is a dynamic communication system with many transmitters and many receivers or users. FIG. 1 shows the high-level schematic of the DFF communication system. Various transmitters (106) receive data through backbone wireline network (103). These data are transmitted to established users (102) using optical beam (104). The users transmit data, including acknowledgement (ACK), back to the transmitter using another optical channel which is omni-directional so that it doesn't need to know the location of the transmitter. Since receiver-to-transmitter (RX-TX) data is low bandwidth, it doesn't need to be directional beam. In the transmitter a high sensitivity avalanche photodiode (APD) is used to detect such signal. This reduces the power required and optical system complexity at the receiver. The communication system as described is still immune to jamming since the RX-TX data is coded with user specific codes established during handshaking such that any uncorrelated signal only degrades signal-to-noise ratio (SNR) but does not completely disrupt the communication. The basic idea of using an FSO communication system to achieve high speed communication has already been published [1]. A high-speed communication at 50 Mbps was established with bit-error-rate (BER) less than 10⁻⁷. However, it didn't include user tracking, beam shaping and beam steering and hence didn't address the user mobility issues. Beam shaping and beam forming also significantly improve SNR and BER. At the same time, it can improve security and immunity from jamming attacks. These features differentiate present invention from other FSO communication systems and RF communication systems.

In RF communication system such as Wi-Fi, the RF signal is broadcast using omni-directional antennas (205) in a wireless router (203). In a simple RF broadcast communication, each packet is received by the user (202) with matching user id or internet protocol (IP) address and decodes the data. There are often multiple channels to allow for parallel transmission of data to multiple users. However, the main drawback of Wi-Fi system is that RF signal is transmitted omni-directionally and hence only small fraction of transmitted power is received at each user and rest is wasted (206). Such systems are also vulnerable to eavesdropping and jamming. Any unwanted user can still detect the Wi-Fi communication and with enough information about the system and encoding can decode the on-going communication. Furthermore, any EMP attack can totally disrupt the communication and cause high security risk.

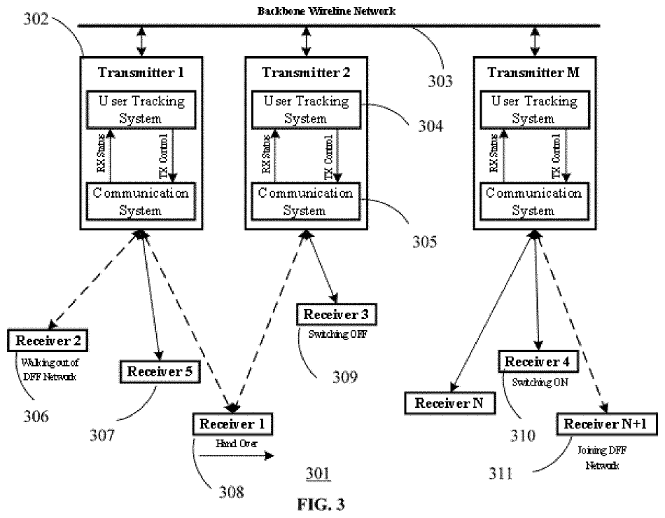

The preferred embodiment of the invention is disclosed in FIG. 3. The DFF communication system (301) is a highly dynamic system with many components and features. FIG. 3 is the high-level system diagram that presents only the basic building blocks. Further details about specific blocks and features, algorithms and signal processing will be discussed later. There is a backbone wireline network (303) to which the DFF connects to in order to access Internet or data from wide area network (WAN). The DFF communication system in a particular installation consists of M transmitters (302) and N receivers (or users) (307), where M is fixed while N is variable and dynamic. The transmitter is divided into two standalone systems, viz user tracking system (304) (UTS) and communication system (305) (CS). The first one is operating at relatively slow speed since it is tracking users who are moving at relatively slow speeds. On the other hand, communication system is operating at several GHz transmitting high-speed data and receiving data requests and acknowledgements. There is communication between two blocks to exchange information about user status and change communication system configuration as users gets added or deleted from a particular femtocell. The users can join DFF communication system (311), leave the system (306), be switched off or become dormant (309) or wake up or become active (310) or walk from one femto-cell to another femto-cell (308). The receivers on the other hand are simple and low power to allow for mobility. The receivers can transmit beacon signal to indicate its presence, retro-reflect optical signal and also transmit signal back using broad optical source. The receivers do not have the capability to do beam forming or beam shaping. Because the RX-TX data is broadcast, it needs to be encoded with proper transmitter address. All these scenarios in addition to dynamic tracking within the femtocell needs to be carefully addressed for a properly functioning communication system as a whole.

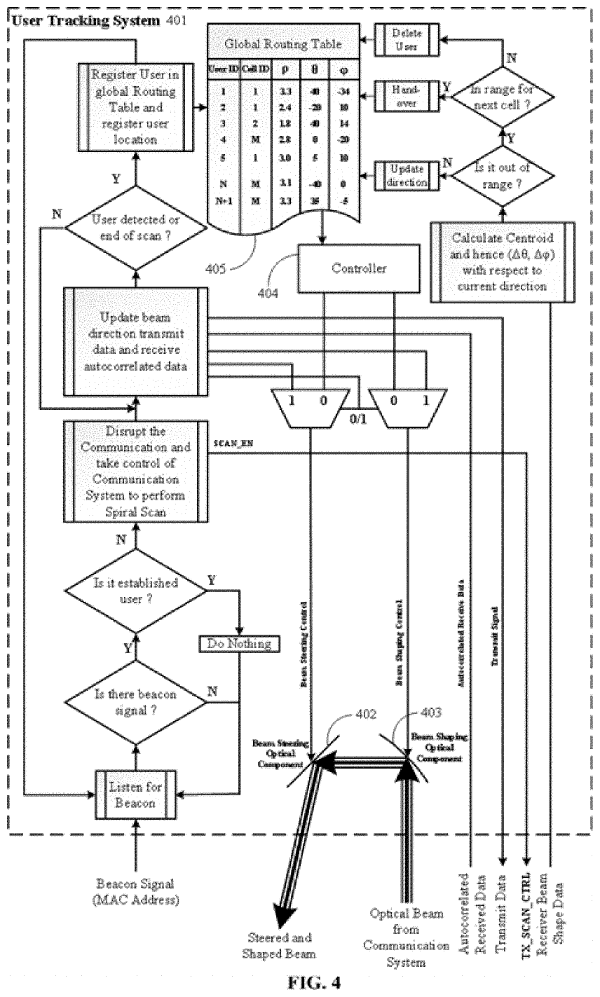

The user tracking system (UTS) is shown in FIG. 4. The UTS consists of at two processes that collaboratively determine which femto-cell a particular user is in and what is its location in terms of direction relative to the transmitter of the femtocell. There is a Global Routing Table (GRT) (405), which is located in a shared memory accessible to all femto-cells via backbone wireline network (303). As such any update to the table is atomic and only one of the femto-cell can write to the table at any moment. Hence the integrity of GRT is maintained even in very dynamic situation. Keeping a single copy of such information is essential to avoid issues with synchronizing multiple copies, latencies and hence possibility of error. Inside a particular transmitter, the GRT is accessible to two processes viz., initial user locating process and user tracking process. The UTS also consists of optical beam steering (402) and beam shaping (403) elements. These elements are in direct control of the UTS.

The initial user locating process begins with detection of beacon signal from a new user. This beacon signal consists of user's unique id such as MAC address. This information is compared against established users in the GRT. If the user is found in GRT, the beacon signal is ignored. If the user is not in GRT, the process continues to find the exact location of the user using spiral scanning technique (701). The UTS now takes control of the communication temporarily halting all active communication to other users in the femto-cell. During this time the optical beam is made wider than usual using beam shaping optical element (403). Then the optical beam is scanned in a spiral fashion starting from the center of the coverage cone of the femto-cell. The Communication System (CS) (501) is switched into scanning mode, where it calculates correlation between transmitted signal and received signal using a correlator (508) and sends this information back to the UTS. The transmitted signal can be pseudo-random signal or a specific code identifying a particular femto-cell. The receiver system (RS) (601) contains a retro-reflecting surface (610), which reflects optical signal in the same direction it was received. So even when the communication hasn't been established, receiver at the very least reflects back the optical signal as it was received. Using this signal, the correlator in CS can determine if the beam is reaching any user. This retro-reflected signal is low power and doesn't disrupt the system during normal communication. Also, the correlator information is ignored if the UTS is not in user locating process. In a situation where the user sends beacon signal but is not in the coverage range of a particular femto-cell, there will be no retro-reflected signal and hence the process will abandon after one full scan. The femto-cell which receives retro-reflected signal registers the user into the GRT. In the case where two femto-cells detect retro-reflected signal, the first-come-first-serve approach is enforced using a rule such that there can be only one entry per user in GRT. After scanning the UTS switches back to regular mode, where it sends signal to communication system by disabling SCAN_EN. In addition to switching to regular mode, the UTS shrinks the beam using beam shaping optical element to allow for maximum signal to noise ratio.

During active communication, UTS keeps track of user mobility using beam shape data (507) from each user in a user tracking process. The shape of the beam received by each user is characterized using a set of PIN diodes (602) spaced apart in a circularly symmetric pattern in each receiver system (601). Due to beam shaping during active communication, the central diode receives the highest power while the other diodes receive lower power. Now if the user moves, the centroid of the beam is displaced by the amount that the user moved, and hence outer diodes start receiving more power. By sending this information to the transmitter and hence UTS, it is possible to have the beam re-directed to correct for the movement. This beam shape data from each user is used in UTS to calculate the centroid and hence the amount of adjustment that needs to be made in the direction of the beam. Once updated direction is calculated, if it is within range of the femto-cell, the GRT is updated with the new location of the user. If the new direction is out of range of current femto-cell, it is determined if it is in range for the next femto-cell. Since the transmitters are at fixed locations, and if there is over-lap between coverage cone of adjacent femto-cells, it is possible to calculate the location of current user with respect to adjacent femto-cell. If it is in range of next femto-cell, this is the case of handover and hence GRT is updated so that user is now associated with new femto-cell. If the new direction is not in any femto-cell coverage cone, the user is deleted from the GRT. This is the case of user leaving the DFF communication system. This completes the life cycle of a user entering the DFF system and leaving the system.

The receiver system while within the DFF system is actively probed by its femto-cell at certain rate even if there is no request for new data. This is called probe packet. This allows receiver to send back beam shape data and acknowledgement. By keeping such infrequent communication, it is possible to even track users who are not actively requesting new data. Now it is however possible that receiver system is turned off while within the DFF system. In such case, a timeout protocol is used.

If a user becomes dormant for any reason, its last location is maintained in the GRT for specific timeout period. After this timeout period, the user is deleted from the GRT. If the user wakes up or starts being active within the timeout period, the communication resumes normally. If it wakes up after timeout period, it is not serviced anymore and hence must start sending beacon signal. This starts the initial user locating process in various UTS and hence user will be located using spiral scanning technique as described before. The timeout period makes sure that if the user becomes dormant and moves to next femto-cell, there is opportunity for it to re-register using beacon signal. As mentioned before only one user entry is allowed in GRT and hence in this situation keeping the user will disallow it from joining another femto-cell. Also, since the user has moved the location information is no more valid. Therefore, timeout is necessary for addressing such scenario. This completes the life cycle of user becoming dormant and returning back to activity within the DFF system.

Although UTS keep tight loop around the communication channel with the user to keep track of the user, it is possible to have lost user situation, where the user is within the DFF system, but its location information is no more valid. Now since the transmitter keeps transmitting the data to the user, it is necessary for the transmitter to receive either acknowledgement (ACK) or negative acknowledgement (NACK) signal in order to keep sending data. If no return signal is received, transmitter assumes that the user has become dormant, stops active communication except for the probe packet and waits for the timeout period as described before. After timeout the user is deleted from GRT and will have to re-register again. This handles the scenario of lost user.

Besides initial user locating process and the user tracking process, the UTS also contains controller which serves as interface to control the beam shaping (403) and beam steering (402) optical elements. In a simple case, the beam shaping can be done using micro-electro-mechanical (MEMS) deformable mirror, while the beam steering can be done using dual axis Galvo-Mirrors. However, this doesn't allow generating multiple beam pattern simultaneously and hence only one user per femto-cell can be addressed at a time. A solution using time division multiple access can be employed where latency in re-directing beam using Galvo-Mirrors is not a problem. However, Galvo-mirror are monotonic deflectors that need to sweep the beam across the cone through a straight line between starting and ending angle and hence random access is not feasible. Due to this there is significant latency if two users are at two ends of the coverage cone of a particular femto-cell. Alternatively, multiple directed beam can be generated using Spatial Light Modulators (SLM). Using SLM, it is possible to divide the optical power into multiple beams directed individually in different direction. However, this requires phase SLM, which in turn requires the coherence length of the light sources be at least the largest distance within each coverage cone. In a similar manner, beam steering can also be done using Digital Micro-mirror Devices (DMD) and Acousto-optic deflector (AOD). This allows for fast steering of beams across the entire coverage cone in less than 1 ms. However, portion of light not being used will be wasted if considering multiple beams simultaneously. If considering single beam at a time, these devices offer much faster response than Galvo-Mirrors. The devices available for beam steering are topic of active research and there are various options available based different trade-off. To the person skilled in art this is an implementation choice and not a feature of invention and hence in this preferred embodiment, the beam steering device is any optical component that can steer the optical beam in response to applied signal, including applying combination of techniques to achieve speed, coverage and efficiency required for particular application. These include Galvo-Mirrors, SLM, DMD, AOD etc. Similarly beam shaping can also be achieved using many techniques and corresponding devices such as MEMS Deformable Mirrors, Liquid Variable Focal Length Lens, Acoustic Optic Lens etc. In this preferred embodiment all of these devices are considered as possible choices and hence referred to here as beam shaping optical element.

The transmitter, in addition to, UTS also contains Communication System (501) (CS), which is a high speed electrical to optical interface with active components for multiplexing and demultiplexing data from various users. It includes high power light source producing collimated optical beam. Various options are available in terms of generating high power light source such as Vertical Cavity Side Emitting Laser (VCSEL), high power Light Emitting Diode (LED) and other solid-state lasers etc. However due to high speed modulation requirement, miniaturized form factor and hence reduced parasitic capacitance is needed. Due to this, VCSEL (502) is the preferred light source at the time of invention which provides enough power at the same time can be modulated at desired speed of few GHz. Many VCSEL are available in the form of array to increase output power and in various form factor. As the processing capability is improving every day, further miniaturization of VCSEL and other light sources are possible which will lead to improve speed for same or higher output power. This is again an implementation choice based on availability which is based on progresses being made in miniaturization of these devices.

For receiving optical signal from the users, the transmitter has an optical receiver such as Avalanche Photo Diode (APD) or a PIN diode. The signal transmitted back from the receiver (users) is not a focused beam and hence sensitivity of receiver needs to be high enough to pick up such signal. On the other hand, it doesn't need to be as fast as transmit signal and hence can integrate received optical signal for longer time to achieve desired SNR. In this preferred embodiment an APD (509) followed by trans-impedance amplifier (TIA) followed by Limiting Amplifier (LA) is considered as preferred signal acquisition chain. Hence in the CS, the transmitted optical signal is generated using a light source that can be modulated at the desired speed such as VCSEL and received optical signal of converted to electrical signal using photo-detector such as APD or PIN device.

The CS receives data to be transmitted to various users in its femto-cell through a serial wireline link, which is the backbone network. This data is further processed to separate data addressed to each user in the femto-cell. Only data addressed to users in a particular femto-cell is received by the CS. Such screening and routing of various packets based on destination address is commonplace in current wireline communication systems such as LAN. The devices that function to perform such selection of data packets and routing is done using devices called Routers. So, in that regard, the CS in each transmitter has built in routing functionality based on GRT. Each data-stream is then processed through Reed-Solomon Forward Error Correcting (FEC) algorithm to add error correction bits. Number of error correction bits determine how many errors can be detected and how many errors can be corrected. For t bit addition, t errors can be detected in a packet, while only t/2 bits can be corrected. The specifics of the error correction number of bits is subject to desired level of bit-error-rate (BER) and channel SNR. Higher SNR will require a smaller number of FEC bits to achieve desired BER, but at the same time for lower SNR, higher number of FEC bits can be added to meet desired BER. Adding large number of FEC bits can reduce data throughput. The encoded data streams are either time division multiplexed (TDM), or code division multiplexed (CDM) depending on whether the beam steering optical element is multi-beam or single-beam at a time. For TDM, the multipliers (504) acts as logical gates that open for specific duration and pass on to the next user. For CDM, the multipliers are all synchronous and multiply the signal set of code, which are orthogonal. Many orthogonal codes are possible such as Hadamard matrix code, which has widely been used in RF based CDMA communications. In this preferred embodiment TDM is used and hence only one of the multipliers are active at a time. However, it is also possible to do CDM as described earlier.

After being modulated, the signal is sent to the mux selector (503), which selects between scan mode data and normal mode data based on signal from the UTS. This signal is then sent to driver and the light source for optical modulation. In this embodiment modulation of the optical signal based on electrical is achieved by directly applying the electrical signal to activate the optical source. It also possible to modulate in optical domain using AOD or other optical modulators. During scan mode the data-stream is received from the UTS. In scan mode, the received data is correlated with transmit data using a correlator (508) and the correlation is sent to UTS. During normal operation this data is ignored by UTS.

In contrast with transmit signal the receive signal must be modulated using CDM since many receivers will be sending data back to the same transmitter. Since each receiver has a unique id, it can be assigned with a unique code from an orthogonal set of codes. The received signal then needs to be decoded in order to separate different data from different users. After demodulation, the beam shape data from each receiver is extracted. This data is always at a specific bit location within a packet and hence can be easily extracted. This information is then sent to the UTS through a data bus (507). This is a unidirectional data bus and hence no addressing is necessary. The data is then used by UTS to determine the centroid of each beam received at each receiver as described before. Rest of the data packet is sent to the upper protocol layer such as application layer.

In addition to transmitters, the DFF system at any time contains N users where N is dynamically changing. The number of users supported will determine the data throughput for each user. Either using TDMA or CDMA the channel capacity remains constant and hence total available bandwidth is constant. With additional users the bandwidth is divided into multiple users.

In the receiver system, there is a circularly symmetric pattern of PIN (602) diodes which serve as optical signal receiver. For normal communication, these signals are simply added up to create a single signal. However, for the purpose of user tracking, these signals are individually sent though low pass filter (LPF) and then to analog to digital converters (ADCs) to determine the analog voltage level at each diode corresponding to optical power at each diode. Since the diodes are spaced apart by the size of the beam, if the user moves, the outer diodes start receiving more power. Depending on which direction user moves, a particular diode receives more power and hence movement can be actively tracked. The orientation of the user with respect to transmitter can be ascertained using dithering technique. Such dithered beams can be transmitted occasionally in order to keep track of user orientation. The receiver system further consists of clock data recovery (603) (CDR) module which extracts the clock signal from the received data stream. For this to work properly, the data stream needs to have no more than certain number of consecutive ones or zeros. This can be achieved by various data padding techniques widely used in existing communication systems. The received data is further demodulated using a multiplier (605) and unique code for each user, which is synchronized to the generated clock. In TDM, this is code is always 1. When data is not being sent to a particular receiver, there is not signal and hence only noise will be detected. At higher protocol layers, packet containing user id will need to be searched for in order to avoid receiving noise. The demodulated signal is then sent through decision element to convert to input bit stream. Then error detection and correction are applied, and data is sent to upper protocol layer.

In addition to physical layer components such as transmitter and receiver system, the DFF system also consists of upper protocol layers such as data-link layer, network layer and transport layer. This functionality can be seamlessly carried out similar to exiting communication protocols such as Wi-Fi and Wi-Max. As the data packet is transmitted and received by the physical layer, the upper protocol layers can operate as it does in current communication systems. The invention and hence preferred embodiment are transparent to upper protocol layers in terms of how the communication is achieved at physical layer.

1. A free space optical communication system comprising:
a plurality of transceivers distributed evenly in space;
a plurality of receivers distributed in space;
wherein line-of-slight between transceivers and receivers is achieved using beam-steering and beam-shaping.

2. The system of claim 1 wherein each transceiver further comprising:
software algorithm to initially locate the receivers using spiral scanning of transmit beam and registering retro-reflected optical power to locate the receivers.

3. The system of claim 2 wherein transceiver comprises of a two-dimensional optical beam steering element and a variable focal length beam shaping optical element.

4. The system of claim 3 wherein each receiver further comprising:
spatially distributed detectors to detect the spatial profile of the beam and a communication method to send back such spatial distribution to the transmitter.

5. The method of claim 4 wherein each transceiver further comprises:
a method to process data sent by the receiver in order to track movement of the receivers and dynamically adapt the beam steering direction.

6. The method of claim 5 wherein each transceiver further comprises:
a method to determine if a user has left the cell and to handover the user to the next femto-cell if it is within its coverage range.

7. A free-space optical communication system comprising:
a plurality transceiver circuits evenly distributed in space comprising:
a. a collimated optical source
b. a pair of beam-steering optical element
c. a variable focal length beam shaping optical element
d. a wide area optical receiver that receives retro-reflected optical signal from receivers; and
a plurality of receivers comprising:
a. photodiode array to receive transmitted optical signal
b. optical filter to reject spurious unwanted optical signal
c. a retro-reflecting optical element
d. a low power optical source for transmitting signal back to the transceiver.

8. The free-space optical communication system of claim 7 further comprising:
software algorithm to initially locate receivers using spiral scanning method;
software algorithm to integrate power level of each receiving photodiodes in software domain;
software algorithm and hardware system to detect user movement with respect to received optical beam;
software algorithm to calculate user location using beam shape data sent by receivers;
software algorithm to keep user location in a central global routing table (GRT).

9. The free-space optical communication system in claim 8 further comprising:
using time division multiple access (TDMA) to allow multiple users in single femto-cell.

10. The free-space optical communication system in claim 8 further comprising:
using code division multiple access (CDMA) to allow multiple users in single femto-cell.

11. The free-space optical communication system in claim 8 wherein the wavelength of transmission is in near infra-red optical region.

12. The free-space optical communication system in claim 11 wherein the wavelength of transmission and reception are different.
